(19) United States
(12) Patent Application Publication
(10) Pub. No.: US 2001/0008413 A1
(43) Pub. Date: Jul. 19, 2001

(54) Video conference control apparatus and method thereof based on MPEG4

(76) Inventor: Gyu Man Lee, Seoul (KR)

Correspondence Address: BIRCH, STEWART, KOLASCH & BIRCH, LLP, P.O. Box 747, Falls Church, VA, 22040-0747, US

(21) Appl. No.: 09/764,119

(22) Filed: Jan. 19, 2001

(30) Foreign Application Priority Data
Jan. 19, 2000 (KR) 2369/2000

(51) Int. Cl. H04N 7/14

(52) U.S. Cl. 348/14.08; 348/14.13

(57) ABSTRACT

The present invention relates to a video conference control apparatus and a method thereof based on a MPEG4 which is capable of performing a video conference by using a MPEG4 system on an IP (Internet Protocol) network. Particularly, the present invention is capable of implementing a MPEG4 video conference system on the IP network, developing products such as a MPEG4-H.323 Gate Way etc. and communicating freely in one space with terminals having different standards by providing an apparatus and a method for performing protocol conversion and connection management in order to perform mutual interlocking with H.323 terminals by using the MPEG4 system.

### BACKGROUND OF THE INVENTION

1. Field of the Invention

The present invention relates to a video conference system, in particular to a video conference control apparatus and a method thereof based on a MPEG4 which is capable of performing a video conference by using a MPEG4 system on an IP (Internet Protocol) network.

2. Description of the Prior Art

The recent increase of interest and use about the internet has been remarkable in comparison with the past because of the spread of personal computers and tremendous increase of internet service providers and internet users.

The internet can overcome spatial limit by connecting a whole world with networks, and can make exploration possible by transcending ideologies and the borders. There is internet services such as a web which has the most many users presently, a FPT (Forced Perfect Termination), a telent, a news, a gopher etc.

However, in order to provide more various services having higher quality, lots of network loads and computational complexity are required.

Accordingly, performance of the PCs and speed of networks are improved by developers according to user requests, and a video conference system which is capable of watching and listening motion pictures and voices of the other party through a network has been developed.

In the present times, the internet adapts an IP (Internet Protocol) standard, a H.323 of an IT-T (The International Telecommunication Union-Telecommunication Standardization Sector) can be represented as a standard of a video conference system through the IP, products adapting the H.323 standard have been developed until now, and more improved version standards will be developed continually.

Meanwhile, an ISO (International Standards Organization) proceeds a standardization of a MPEG4 (Motion Pictures Expert Group4) providing circumstances which is capable of developing a unification multimedia application through a network, and various applications of the MPEG4 system are possible through various media.

The MPEG-4 is the standard for the next generation multimedia, it is standardized by a SG29 WG11 which is an affiliated organization of the ISO (International Organization for Standardization)/IEC (International Electrotechnical Commission), and it has wide application such as a broadcast, a home shopping using a broadcast, an education program an amusement program a home shopping program an information guide program using real-time motion pictures, animations and voice transmissions on the internet and etc.

The MPEG-4 is an object directive system which is capable of constructing a whole by regarding each media used in the conventional multimedia communication as one object, and performing independent processing about the object.

Because it is possible to perform the independent processing about the multimedia object, a contents producer can select a compression method which has a maximum efficiency about the each object after recording the each object independently, and can develop various multimedia contents by using the plurality of objects.

In addition, because it can comprises contents about relation between the objects and access of a user about the object, it can provide not contents which is unilateral and fixed but a scenario which is capable of altering in accordance with intentions of the user, and it deals with problems related to a copyright of the multimedia contents by providing access limitation according to the copyright of the contents.

However, the conventional technology can not provide a video conference system using the MPEG4 on the IP network.

In addition, the conventional technology can not perform interlocking between the H.323 and MPEG4 which are the main currents in the present times.

In addition, the MPEG4 system in accordance with the conventional technology can not influence expansion of the video conference product market because it can not perform the interlocking with the H.323.

### SUMMARY OF THE INVENTION

The object of the present invention is to provide a video conference system based on a MPEG4 which is capable of interlocking with a H.323 terminal mutually and implementing a video conference on an IP network on the basis of a MPEG4 technology.

The other object of the present invention is to provide an apparatus and a method for managing conversion and connection of a control signal for the MPEG4 video conference which is capable of making the video conference system using the MPEG4 system interlocking with the H.323 terminal mutually.

The other object of the present invention is to provide an apparatus and a method for managing conversion and connection of a control signal which is capable of converting a DMIF (Delivery Multimedia Intergration Framework) signal used for a session setting into a Q.931, H.245 used in the H.323 through the network.

The other object of the present invention is to provide the MPEG4 system which is capable of making clear not only interaction between the MPEG4 systems but also interaction between H.323 terminals through a DMIF hierarchy by a method same with a process between the MPEG4 systems.

The other object of the present invention is to provide a MPEG4 video conference system which is capable of using both the method adapting the process of the present invention and a method using a DMIF signal of the inherent MPEG4 when the other party uses the MPEG4 video conference system according to present invention.

The other object of the present invention is to provide a MPEG4 video conference method which is capable of performing a session process through the inherent DMIF (Delivery Multimedia lntergration Framework) signal when the other party uses the conventional MPEG4 video conference system, and performing the process of the present invention when the other party uses the H.323 terminal. Accordingly, the present invention can perform the mutual interlocking between the H.323 terminals, and there is no need to consider a terminal of the other party in the superior application hierarchy.

In order to achieve the above-mentioned objects, the MPEG4 video conference system for constructing a hierarchical video conference system on the IP network in accordance with the present invention comprises a MPEG4 system for performing compression-coding of a multimedia object including a motion picture, a DMIF (Delivery Multimedia lntergration Framework) for transmitting multimedia data including the motion picture from the MPEG4 system through a network in order to perform a video communication, a control signal conversion and connection management mean for performing a message and a signal conversion in order to provide a service according to a service request from the superior hierarchy through a lower hierarchy when the DMIF signal from the DMIF (Delivery Multimedia Intergration Framework) is inputted through the network, and a H.323 terminal for performing a call and a control signal connection for the video conference by connecting to the control signal conversion and connection management mean.

In order to achieve the above-mentioned objects, the control signal conversion and connection management mean in accordance with the present invention comprises a connection manager interface for connecting to the superior DMIF with transmission factor same with the DNI for the inherent DMIF signal, an input signal synchronization mean for providing synchronous of an input signal about the service request inputted from the superior DMIF through the connection manager interface and the confirmation request from the lower hierarchy (H.245)(Q.931), a state management mean for performing a transition control and a service control of a state related to a call and a connection control for the MPEG4 video conference, a message interpretation and service distribution mean for performing interpretation about the synchronized and ordered service input from the input signal synchronization mean and the service distribution through the state management, a control signal converting mean for converting the signal inputted through the connection manager interface into a service request factor of a signal corresponding to the H.245, Q.931, and a connection manager information/resources management mean for performing call (Q.931) connection and control signal (H.245) connection management by linking with the message interpretation and service distribution unit and managing the network resources for the control signal channel.

In order to achieve the above-mentioned objects, in the control signal conversion and connection management mean in accordance with the present invention, the input signal synchronization mean comprises a sub module interface for the service request and reply between the H.245, Q.931, an input queue for performing ordering and a mutual exclusion function about the input from the connection manager interface and sub module interface, and a queue message pump for providing orderly the contents of the input queue for the message interpretation.

In order to achieve the above-mentioned objects, in the control signal conversion and connection management mean in accordance with the present invention, the message interpretation and service distribution mean comprises a message interpretation mean for interpreting the synchronized and ordered message in the input signal synchronization mean and providing it to the control signal conversion mean, and a service distribution mean for performing the pertinent service module under control of the state management mean.

In order to achieve the above-mentioned objects, in the control signal conversion and connection management mean in accordance with the present invention, the connection manager information/resources management mean comprises a network resources management mean for performing allotment about the network resources for the control signal connection and management about the resources information, a connection information management mean for managing connection information of the network and lower hierarchy by the message interpolation and service distribution mean, a call connection management mean for managing the cal connection for the MPEG4 (Motion Pictures Expert Group4) video conference by the connection information management mean, and a control signal connection management mean for managing the control signal connection for the MPEG4 video conference by the connection information management mean.

In order to achieve the above-mentioned objects, the video conference control method based on the MPEG4 in accordance with the present invention for performing the video communication control with six states such as an IDLE, a CALLING, a CALLED, a CONNECTING, a CONNECTED, a DISCONNECT by the control apparatus of the video conference based on the MPEG4 on the IP network comprises a IDLE state defined as the initial state or the state when the call connection and control signal connection are not performed, a CALLING state defined as the state which receives the connection request from the user and requests the call connection, a CALLED sate defined as the sate which receives the call connection request from the other party and allows the connection by the user or which requests the call connection to the other party and receives a signal permitting the connection from the other party, a CONNECTING state defined as the state which connects the control signal, a CONNECTED state defined as the sate which finishes the connection process of the control signal, and a DISCONNECT state defined as the state when the call connection release and control signal connection release are requested. Herein, the video conference control method based on the MPEG4 in accordance with the present invention is performed by returning to the different state according to the condition of the each state.

In order to achieve the above-mentioned objects, in transition and return to the other state according to the conditions of the each state of the video conference control method based on the MPEG4 in accordance with the present invention, (a) the transition from the IDLE state to the CALLING state or CALLED state and transition (return) from the CONNECTING state or CONNECTED state or DISCONNECT state to the IDLE state are performed, (b) the transition from the CALLING state to the IDLE state or CALLED state is performed, (c) the transition from the CALLED state to the IDLE state or CONNECTING state is performed, (d) the transition from the CONNECTING state to the IDLE state or CONNECTED state or DISCCONNECT state are performed, (e) the transition from the CONNECTED state to the DISCONNECT state or IDLE state is performed, and (f) the transition from the DISCONNECT state to the IDLE state is performed.

In order to achieve the above-mentioned objects, in the IDLE state of the video conference control method based on the MPEG4 in accordance with the present invention, the present invention receives a Q.931 call message from remote place, performs a connection confirmation request to the DMIF (Delivery Multimedia Intergration Framework), receives a reply about the connection from the DMIF, and performs the transition from the IDLE state to the CALLED state when the reply mode setting is requested to the H.245. The DMIF requests the connection when it is requested from the remote place first, and the transition from the IDLE state to the CALLED state is performed when the call/connection request to the remote place is succeed.

In order to achieve the above-mentioned objects, in the CALLING state of the video conference control method based on the MPEG4 in accordance with the present invention, the transition from the CALLING state to the IDLE state is performed when the connection release is requested from the DMIF and the call release is requested from the remote place, the transition from the CALLING state to the CALLED state is performed when the reply about the call connection request is received from the remote place.

In order to achieve the above-mentioned objects, in the CALLED state of the video conference control method based on the MPEG4 in accordance with the present invention, the transition from the CALLED state to the IDLE state is performed when the connection release is requested from the DMIF or the call release request is received from the remote place, and the transition from the CALLED state to the CONNECTING state is performed while requesting a TCS and MSD signal process of the H.245 when use right is received from the H.245 (control signal connection).

In order to achieve the above-mentioned objects, in the CONNECTING state of the video conference control method based on the MPEG4 in accordance with the present invention, the transition from the CONNECTING state to the CONNECTED state is performed when the H.245 is in the CONNECTION state, the transition from the CONNECTING state to the IDLE state is performed when the user removal and call release are requested from the H.245, and the transition from the CONNECTING state to the DISCONNECT is performed when the connection release is requested from the DMIF.

In order to achieve the above-mentioned objects, in the DISCONNECT state of the video conference control method based on the MPEG4 in accordance with the present invention, it waits until the processing for the control signal connection finish of the H.245 is completed, and the transition from the DISCONNECT state to the IDLE state is performed when the control signal connection finish processing is completed.

In order to achieve the above-mentioned objects, in the CONNECTED state of the video conference control method based on the MPEG4 in accordance with the present invention, the transition from the CONNECTED state to the DISCONNECT is performed in order to finish the connection when the DMIF connection release request event for performing the connection release process by the request of the user, the H.245 user removal request for finishing the connection from the remote place, and the Q.931 connection release request are received.

In order to achieve the above-mentioned objects, the video conference control apparatus based on the MPEG4 in accordance with the present invention for constructing hierarchical video conference system on the IP network comprises a DMIF on the superior hierarchy, a Q.931 and H.245 on the lower hierarchy, an interface having a transmission factor same with the DNI in order to perform the MPEG4 video communication through the H.245 and Q.931 placed on the lower hierarchy when the DMIF signal to be transmitted through the network is inputted through the DNI from the DMIF, and a service request and reply control mean for controlling the service request and replay by converting the signal inputted through the interface into a service request factor of a signal corresponding to the H.245 and Q.931.

### BRIEF DESCRIPTION OF THE DRAWING

FIG. 1 is a schematic block diagram illustrating a link construction of an IP network and a video conference system in accordance with the embodiment of the present invention.

FIG. 2 is a block diagram illustrating a MPEG4 video conference control system.

FIG. 3 illustrates a construction of a control signal conversion and connection manager of the MPEG4 video conference control system of FIG. 2.

FIG. 4 illustrates a detailed construction of the control signal conversion and connection manager of the MPEG4 video conference control system of FIG. 2.

FIG. 5 illustrates state alternation performed on a state manager.

FIG. 6A and 6B are a flow chart illustrating control order performed in an IDLE state which is not connected to a remote place.

FIG. 7 is a flow chart illustrating a CALLING state which requests connection from a region to the remote place.

FIG. 8 is a flow chart illustrating a CALLED state after transition from the IDLE state of FIG. 6A, 6B and CALLING state of FIG. 7.

FIG. 9A and 9B are a flow chart illustrating a state for waiting completion of a TCS (Terminal Capability Set) and a MSD (Master Slave Determination) process which are required for a H.245.

FIG. 10 is a flow chart illustrating a state for finishing the connection which is a CONNECTED state or a CONNECTING state before the transition to the IDLE state.

FIG. 11A and 11B illustrate order related to a message reception and a DMIF connection release request reply in the CONNECTED state in accordance with the present invention.

FIG. 12 illustrates order related to a request and a reply of the DMIF service start and H.245 service connection request and confirmation.

FIG. 13 illustrates order related to a request and a reply of the DMIF service finish and H.245 service release request and confirmation.

FIG. 14 illustrates order related to the DMIF channel open request and replay and H.245 channel open and confirmation.

FIG. 15 illustrates order related to the DMIF channel close request and reply and H.245 channel close request and confirmation.

### DETAILED DESCRIPTION OF THE PREFERRED EMBODIMENT

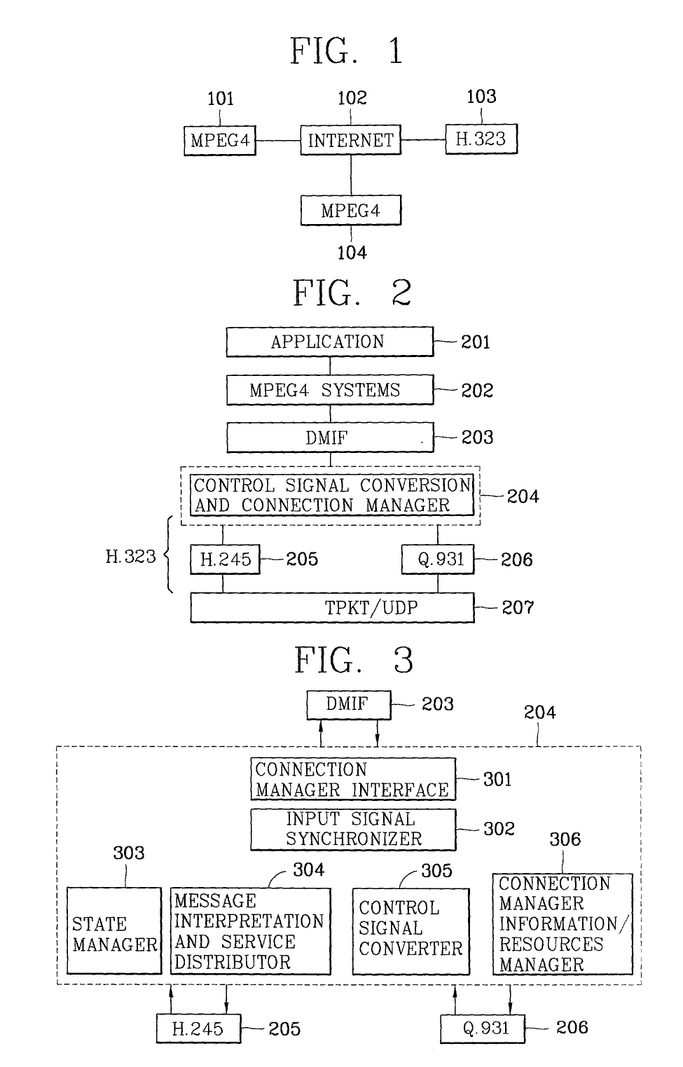

FIG. 1 is a schematic block diagram illustrating a link construction of an IP network and a video conference system in accordance with the embodiment of the present invention.

As depicted in FIG. 1, the present invention comprises a MPEG4 video conference system 104 according to the present invention which is connected to the internet 102, a MPEG4 video conference system 101 which does not adapt the present invention, and a H.323 terminal. Its construction will now be described in detail.

First, the MPEG4 video conference system 104 adapting the present invention can use both methods. In other words, it can use the method adapting the present invention when the other party uses the MPEG4 system adapting the present invention, and it also can use the other method using a DMIF signal of the conventional MPEG4.

On the contrary, the MPEG4 video conference system 104 adapting the present invention performs a session process through the DMIF signal when the other party uses the MPEG4 video conference system 101 which does not adapt the present invention.

In addition, the MPEG4 video conference system 104 adapting the present invention uses a session process of the present invention when the other party uses the H.323 terminal 103, accordingly it performs a mutual interlocking with the H.323 terminal 103. Herein, it provides clarify which does not consider the terminal of the other party to the superior application hierarchy. It will now be described in detail with reference to accompanying FIG. 2.

FIG. 2 is a block diagram illustrating a MPEG4 video conference control system.

As depicted in FIG. 2, the MPEG4 video conference system adapting the present invention is implemented by comprising a superior application 201, a MPEG4 system 202, a DMIF (Delivery Multimedia Intergration Framework) 203, a control signal (H.245; Multimedia Control Protocol) conversion and connection manager 204, a H.245 205 corresponding to a lower H.323 terminal, a Q.931 206, and a TPKT(T-Packet)/UDP(User Datagram Protocol) 207. Its operation will now be described in detail.

First, when a DMIF signal which is transmitted through a network on the DMIF (delivery Multimedia lntergration Framework) is inputted through a DNI (DMIF Network Interface), the control signal conversion and connection manager 204 provides conversion of a message and signal process in order to transmit it through the H.245 205 and Q.931 206 on the lower hierarchy.

Accordingly, the DMIF 203 is placed on the superior hierarchy of the control signal conversion and connection manager 204, and it has an interface same with the DNI.

In addition, the H.245 205 and Q.931 206 are placed on the lower hierarchy of the control signal conversion and connection manager 204, and the service request from the superior hierarchy is transmitted through the H.245 205 and Q.931 206 signals.

Hereinafter, the control signal conversion and connection manager 204 will now be described in more detail with reference to accompanying FIG. 3.

FIG. 3 illustrates a construction of a control signal conversion and connection manager of the MPEG4 video conference control system of FIG. 2. In other words, it describes the control signal conversion and connection manager 204 in more detail by displaying service modules.

As depicted in FIG. 3, the control signal conversion and connection manager 204 for the MPEG4 video conference on the IP network in accordance with the present invention comprises a connection manager interface 301 for connecting to the superior hierarchy of the DMIF (Delivery Multimedia lntergration Framework) 203 with transmission factor same with the DNI for the inherent DMIF signal, an input signal synchronizer 302 for providing synchronous of an input signal about the service request inputted from the DMIF through the connection manager interface 301 and the confirmation request from the lower hierarchy H.245 205 and Q.931 206, a state management mean 303 for performing a transition control of a state related to a call for the MPEG4 video conference (Q.931) and a connection processing and a service control, a message interpretation and service distributor 304 for performing interpretation about the synchronized and ordered service input from the input signal synchronizer 302 and performing the service distribution through the state management, a control signal converter 305 for converting the signal inputted through the connection manager interface 301 into a service request factor of a signal corresponding to the H.245 205 and Q.931 206, and a connection manager information/resources manager 306 for performing call (Q.931) connection and control signal (H.245) connection management by linking with the message interpretation and service distributor and managing the network resources for the control signal channel. Its operation will now be described in detail.

First, a service contact point of the present invention is performed from the DMIF 203 through the connection manager interface 301. Herein, the provided connection manager interface 301 has a transmission factor same with the DNI for the inherent DMIF signal in order to provide a maximum clarify to a module taking the service of the present invention.

The input signal synchronizer 302 provides a synchronous of an input signal about the confirmation request transmitted from the H.245 205 and Q.931 206 as the lower hierarchy.

In addition, the ordering of an input through a plurality of tasks is performed as an input signal through one task by the input signal synchronizer 302.

In other words, the input signal synchronizer 302 provides a service request inputted from the DMIF 203, a synchronization about the confirmation request from the lower hierarchy H.245 205 and Q.931, and ordered information about the plurality of task inputs.

The state manager 303 manages the process for performing the all controls of the present invention, it performs overall control in order to provide a service corresponding to the present state about the continuous input.

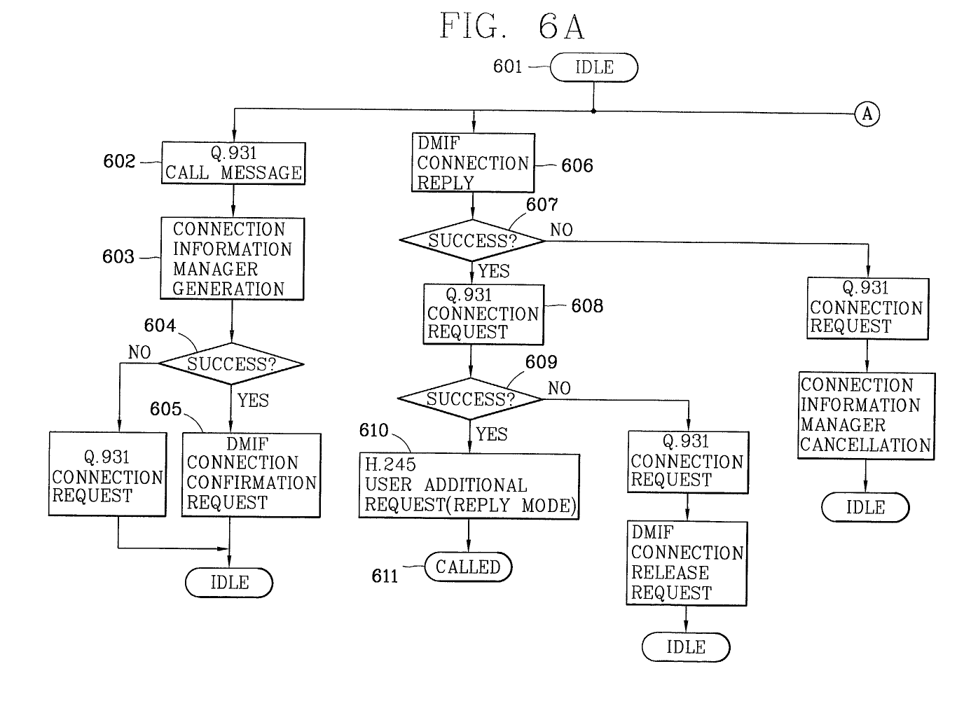

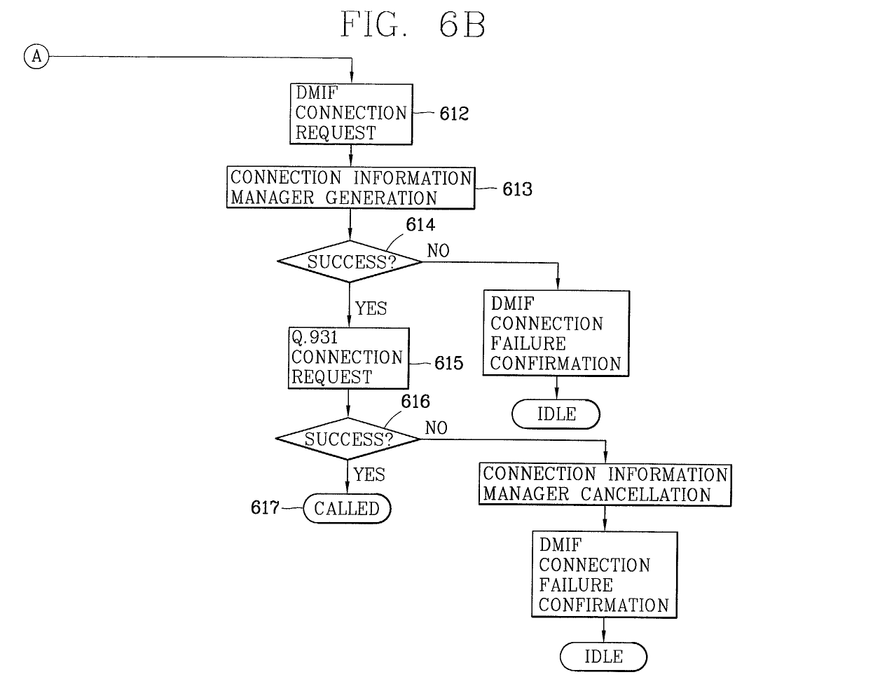

In addition, the state alternation of the state manager 303 is described in FIG. 5, and the control orders in accordance with the each state is described in FIG. 6˜FIG. 15. The detailed explanation will now be described with reference to accompanying FIG. 6˜FIG. 15.

Meanwhile, the message interpretation and service distributor 304 performs the interpretation about the information (service input) which is synchronized and ordered by the input signal synchronizer 302.

In addition, the message interpretation and service distributor 304 performs the pertinent service by selecting an appropriate service through the state manager 303.

And, because the signal inputted through the connection manager interface 301 has a transmission factor same with the DNI for the inherent DMIF signal, the control signal converter 305 provides a function for converting it into a service request factor corresponding to the H.245 205 and Q.931 206.

The connection manager information/resources manager 306 manages the call (Q.931) connection and control signal (H.245) connection required in the connection process to the remote place system through the network.

In other words, because the call (Q.931) connection and control signal (H.245) connection are separately performed through the different channel, the connection management information/resources manager 306 performs the management about the connection information between them.

Herein, the call means a signaling for a call, an ITU-T proclaims to use the Q.931 as a call control protocol on the H.323. In addition, the control signal means the H.245, and it is the Multimedia Control Protocol.

Herein, a plurality of channels can be used for the control signal (H.245) connection, the connection management information/resources manager 306 performs the management of the network resources for the control signal channel.

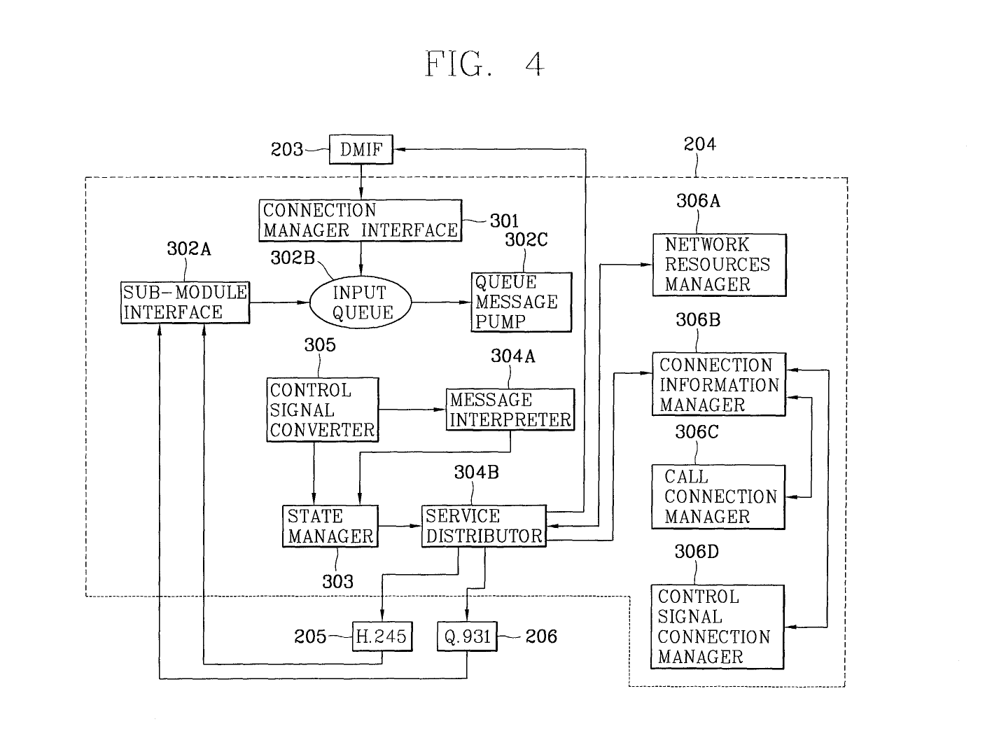

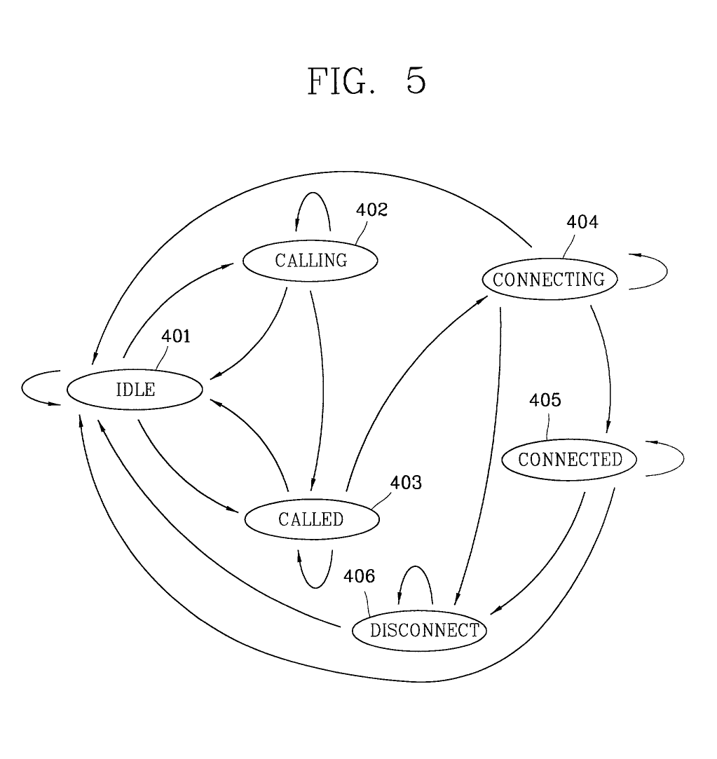

Hereinafter, the control signal conversion and connection manager for the MPEG4 video conference on the IP network in accordance with the present invention will now be described with reference to accompanying FIG. 4.

FIG. 4 illustrates a detailed construction of the control signal conversion and connection manager of the MPEG4 video conference control system of FIG. 2. In other words, it describes the detailed explanation and control signal about the superior hierarchy DMIF 203, lower hierarchy H.245 205, Q.931 206, and inner construction module.

As described in FIG. 4, the input signal synchronizer 302 comprises a sub module interface 302A, an input queue 302B, and a queue message pump 302C. The message interpretation and service distributor 304 comprises a message interpreter 304A, and a service distributor 304B. The connection manager information/resources manager 306 comprises a network resources manager 306A, a connection information manager 306B, a call connection manager 306C, and a control signal connection manager 306D, the connection of each construction will now be described.

First, the input of the input queue 302B is connected to the output of the connection management interface 301 and sub module interface 302A, the output of the input queue 302B is connected to the input of the queue message pump 302C.

In addition, the output of the queue message pump 302C is connected to the input of the message interpreter 304A, the output of the message interpreter 304A is connected to the input of the control signal converter 305 and state manager 303.

Herein, the output of the control signal converter 305 and the output of the message interpreter 304A are connected to the input of the state manager 303, and the output of the state manager 303 is connected to the input of the service distributor 304B.

In addition, the network resources manager 306A and connection information manager 306B are connected to the service distributor 304B, and the connection information manager 306B, call connection manager 306C and control signal connection manager 306D are connected each other.

In addition, the output of the service distributor 304B is connected to the input of the DMIF 203, and it is also connected to the input of the h.245 205 and Q.931 206.

The output of the H.245 205 and Q.931 206 are connected to the input of the sub module interface 302A.

The operation of the control signal conversion and connection manager for the MPEG4 video conference of the present invention will now be described in detail.

First, all service requests are transmitted from the DMIF 203 through the connection manager interface 301, and a module requesting the service of the present invention such as the DMIF 203 is called as a user.

Meanwhile, the method for informing the reply about the request service from the DMIF 203 or the request about the service transmitted from the remote place is performed through a channel registered in the process for initializing the present invention by the DMIF 203.

The input signal synchronizer 302 is described in detail by dividing into the sub module interface 302A, input queue 302B, and queue message pump 302C.

Herein, the sub module interface 302A requests the service from the H.245 205 or Q.931 206 as the lower hierarchy of the present invention, and is used as a channel for transmitting the pertinent signals (information) when it receives the reply about the request service or the Q.931 206 signal message, H.245 205 signal message transmitted from the remote place.

The contact point of the sub module interface 302A is set in the process for initializing the lower hierarchy module H.245 and Q.931.

And, the input queue 302B performs an ordering function for processing the inputs from the multi task according to weight of the service and a mutual exclusion function for preventing cross-wires of the input from the superior and lower hierarchies in the system control request process.

Herein, the contents of the input queue 302B is taken out through the queue message pump 302C, and is transmitted to the message interpreter 304A, all messages are interpreted through the message interpreter 304A, and are passed through the control signal converter 305 according to situations or are directly passed through the state manager 303, accordingly the next service is determined.

The control signal converter 305 performs the function for converting the factor transmitted from the superior hierarchy DMIF 203 into the factor used in the lower hierarchies H.245 signal or Q.931 signal.

In addition, the control signal provides a pre-processing function for performing the factor conversion before it transmits the H.245 signal or Q.931 signal received from the remote place to the superior hierarchy DMIF 203.

Herein, the state manager 303 provides a function for performing the appropriate service corresponding to the present state about all inputs of the present invention, and the it is the important module of the present invention with the control signal converter 305.

The state transition about the state manager 303 will now be described in detail.

Meanwhile, the service distributor 304B performs the function for making the module selected by the state manager 303 perform the service directly.

In other words, it performs the service distribution to the H.245 205 or Q.931 206 or network resources manager 306A in order to perform the pertinent service directly corresponding to the input from the state manager 303.

Herein, the service distribution is performed through the network resources manager 306A or connection information manager 306B in order to get information needed for the service execution or information alternation after the service execution.

After that, the connection information manager 306B is operated by the request from the service distributor 304B, the detailed function of the connection information manager 306B is performed through the call connection manager 306C and control signal connection manager 306D.

The call connection manager 306C manages the information for the initial call connection to the remote place, and the control signal connection manager 306D performs the management about the control signal connection information to the remote place.

Each information of the call connection manager 306C and each information of the control signal connection manager 306D are combined as a pair, and the connection information manager 306B combines and manages the such information.

Accordingly, when one connected remote place is added, one information is added to the information of the connect information manager 306B, and one information is separately added to the information of the call connection manager 306C and information of the control signal connection manager 306D.

And, the network resources manager 306A performs the management about the network resources for the control signal connection and management of the network resources information. Herein, the control signal connection is required elucidation about the network resources to be used at the channel setting time point different from the call connection.

Accordingly, management of the required network resources has to be performed because the network resources is used after judging whether the network resources can be used.

Hereinafter, the state alternation performed by the state manager 303 will now be described in detail with reference to accompanying FIG. 5.

FIG. 5 illustrates the state alternation performed in the state manager 303 in accordance with the present invention. In other words, it describes the state alternation performed in the state manager 303, the state manager 303 has the six states, namely, IDLE, CALLING, CALLED, CONNECTING, CONNECTED, DISCONNECT, the explanation about the each state will now be described in detail.

First, the IDLE state is defined as the initial state or the state when the call connection and control signal connection are not performed, a CALLING state is defined as the state which receives the connection request from the user and requests the call connection.

The CALLED sate is defined as the sate which receives the call connection request from the other party and allows the connection by the user or which requests the call connection to the other party and receives a signal permitting the connection from the other party, the CONNECTING state is defined as the state which connects the control signal.

The CONNECTED state is defined as the sate which finishes the connection process of the control signal, and the DISCONNECT state is defined as the state when the call connection release and control signal connection release are requested.

As described above, the transition control of the six states is performed as below (a)˜(f).

(a) The transition from the IDLE state to the CALLING state or CALLED state and transition (return) from the CONNECTING state or CONNECTED state or DISCONNECT state to the IDLE state are performed.

(b) The transition from the CALLING state to the IDLE state or CALLED state is performed.

(c) The transition from the CALLED state to the IDLE state or CONNECTING state is performed.

(d) The transition from the CONNECTING state to the IDLE state or CONNECTED state or DISCCONNECT state are performed.

(e) The transition from the CONNECTED state to the DISCONNECT state or IDLE state is performed.

(f) The transition from the DISCONNECT state to the IDLE state is performed.

As described above, the state management control is performed in accordance with the state diagram of FIG. 5, and the order (a)˜(f) of transition control will now be described in detail with reference to accompanying FIG. 6˜FIG. 15.

FIG. 6A and 6B are a flow chart illustrating control order performed in an IDLE state which is not connected to a remote place.

As depicted in FIG. 6A and 6B, in the IDLE state, a Q.931 206 call message is received from the remote place, the connection confirmation request is performed to the DMIF 203, a reply about the connection is received from the DMIF 203, and the transition from the IDLE state to the CALLED state is performed when the reply mode setting is requested to the H.245 205. The DMIF requests the connection when it is requested from the remote place first, and the transition from the IDLE state to the CALLED state is performed when the call/connection request to the remote place is succeed.

First, the IDLE state is the state receiving the connection request from the remote place, in the IDLE state 601, the Q.931 call message is received 602, the connection information manager is generated 603, when the generation of the connection information manager is performed 604, the DMIF connection confirmation request is performed 605, the DMIF connection reply is received 606, when the replay is received 607, the Q.931 connection request is performed 608, when the Q.931 connection request is performed 609, the H.245 user additional request (reply mode) is transmitted 610, and the transition is performed to the CALLED state 611.

On the contrary, when the connection is requested from the region, the DMIF 203 requests the connection, and it is altered into the CALLED state when the call connection request to the remote place is succeed.

In other words, when the connection is requested from the region first, it is replied to the DMIF connection request 612, the connection information manager is generated 613, when the generation of the connection information manager is performed 614, the Q.931 connection request message is transmitted 615, when it is succeed 616, and the transition is performed to the CALLING state 617.

When the each above-described process (604, 607, 609, 614, 616) is failed, the processes up to present are all canceled, and the IDLE state is continued.

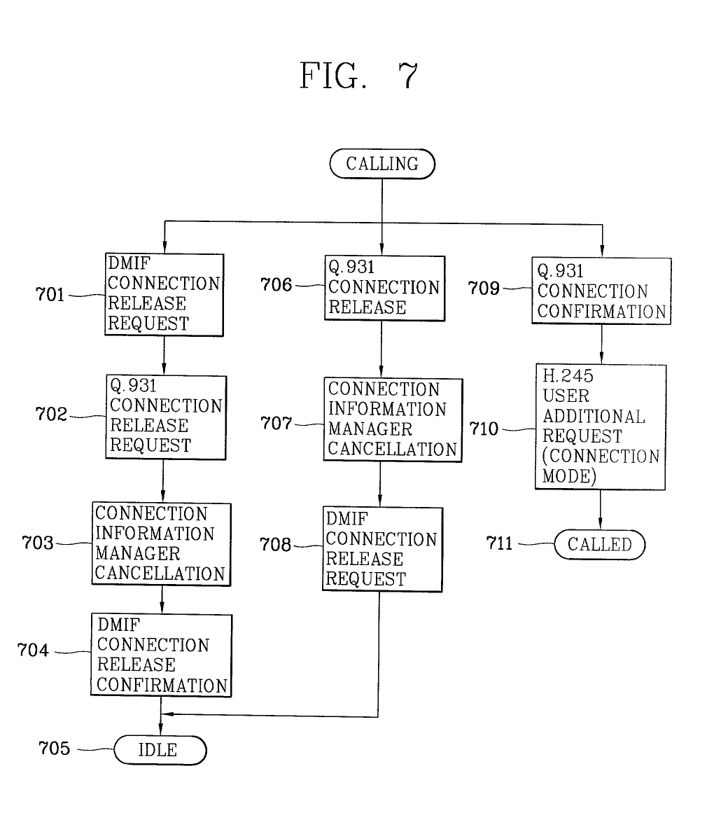

FIG. 7 is a flow chart illustrating the CALLING state which request the connection from the region to the remote place.

As depicted in FIG. 7, the transition from the CALLING state to the IDLE state is performed 705 when the connection release is requested from the DMIF 701 and the call release is requested from the remote place 706, the transition from the CALLING state to the CALLED state is performed 711 when the reply about the call connection request is received from the remote place 709.

First, when DMIF requests the call release 701, the connection information manager 703 is canceled by requesting the call release of the Q.931 703, the connection release confirmation is performed to the DMIF 704, and the transition to the IDLE state is proceeded 705.

In addition, when the call release request is received from the remote place 706, the connection information manager is canceled 707, the connection release request is performed to the DMIF, and the transition to the IDLE state is proceeded 708, 705.

And, when the reply about the call connection request is received from the remote place 709, the H.245 user additional request (connection mode) is performed 710, and the transition to the CALLED state is performed 711.

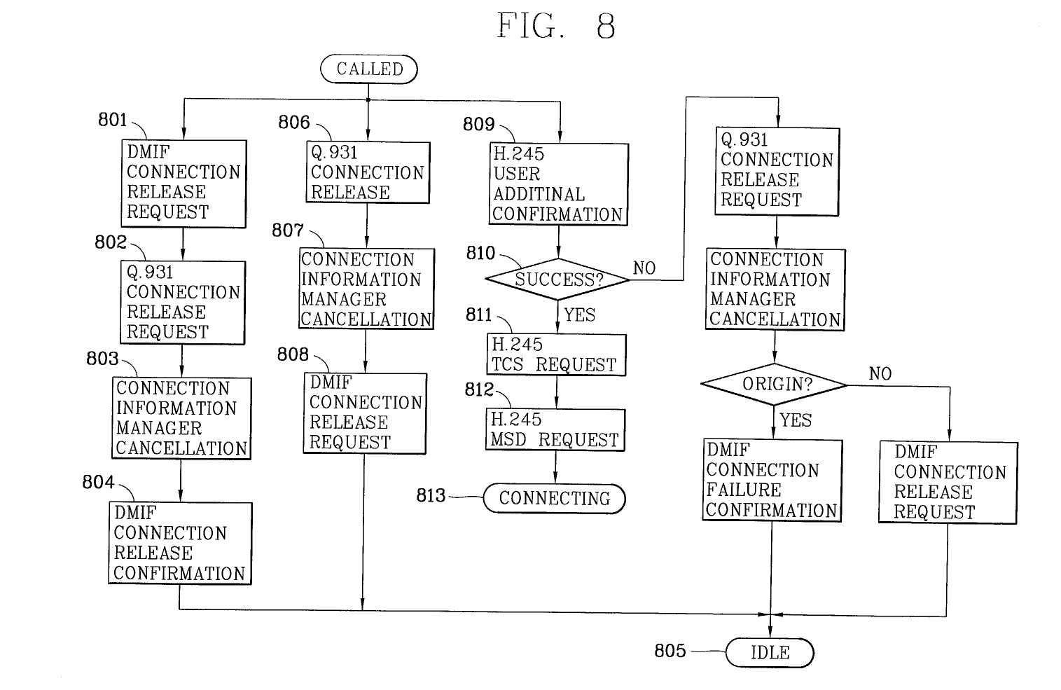

FIG. 8 is a flow chart illustrating a CALLED state after transition from the IDLE state of FIG. 6A, 6B and CALLING state of FIG. 7. As depicted in FIG. 8, the transition from the CALLED state to the IDLE state is performed 805 when the connection release is requested from the DMIF 801˜804 or the call release request is received from the remote place 806˜808, and the transition from the CALLED state to the CONNECTING state is performed 809˜813 while requesting a TCS and MSD signal process of the H.245 when a use right from the H.245 is given (control signal connection).

And, when the each above-described process (801˜804, 806˜813) is failed, the processes up to the present are all canceled, and the IDLE state is continued.

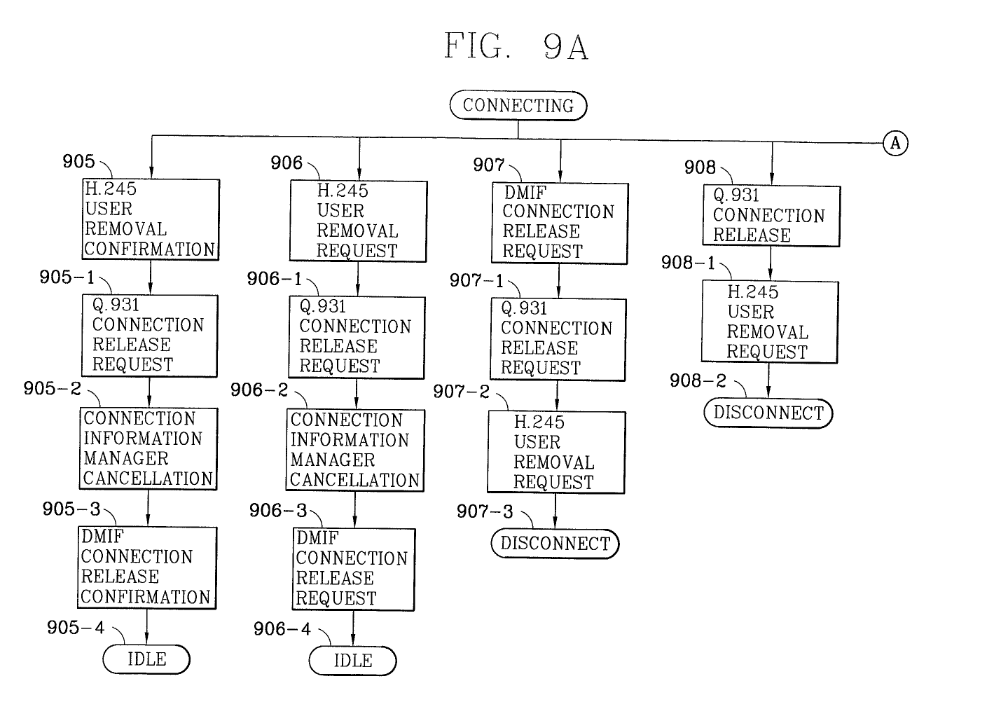

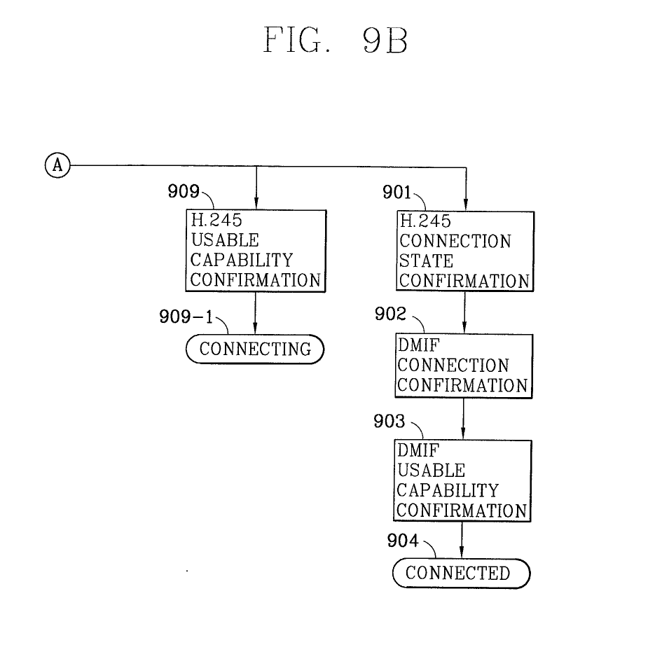

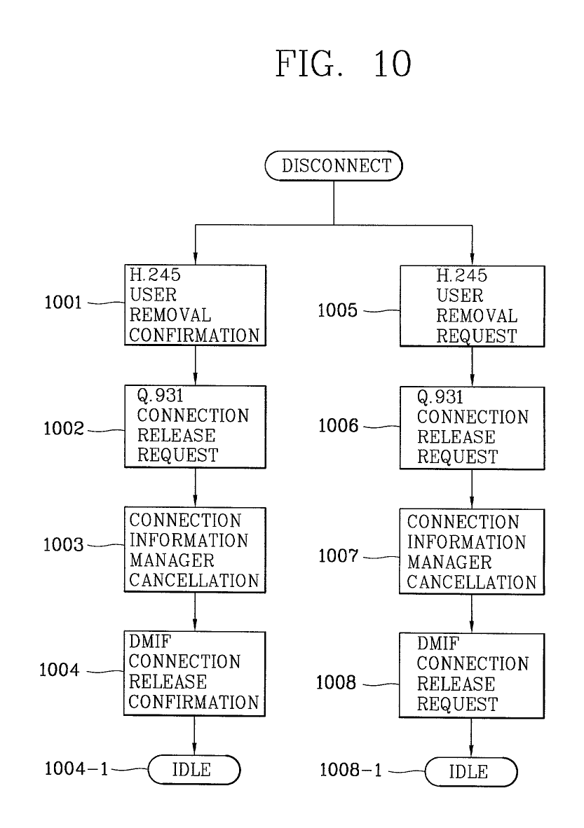

FIG. 9A and 9B are a flow chart illustrating a state for waiting completion of a TCS (Terminal Capability Set) and a MSD (Master Slave Determination) process which are required for a H.245.

As depicted in FIG. 9A and 9B, it is the state waiting the completion of the TC, MSD which are needed processes in the H.245, when the H.245 is in the connection state, it is altered into the CONNECTED state, it will now be described in detail as below.

First, when the H.245 connection state confirmation message is received 901, the connection confirmation is requested to the DMIF 902, the DMIF available capability confirmation is requested 903, and it is altered into the CONNECTED state 904.

In addition, when the H.245 user removal confirmation message is received from the CONNECTING state 905, the H.245 user removal request message is received 906, the Q.931 connection release request (905-1, 906-1), the connection information manager cancellation (905-2, 906-2) and the DMIF connection release confirmation (905-3)/request (906-3) are performed, and the transition is performed to the IDLE state 905-4. 906-4.

In addition, in the CONNECTING state, when the DMIF connection release request service reply is performed 907, the Q.931 connection release request 907-1, H.245 user removal request are performed, and the transition is performed to the DISCONNECT state 907-3.

In addition, in the CONNECTING state, when the Q.931 connection release message is received 908, the H.245 user removal request is performed 908-1, and the transition is performed to the DISCONNECT state 908-2.

In addition, when the H.245 usable capability confirmation message is received 909, the transition is performed to the CONNECTING state 909-1.

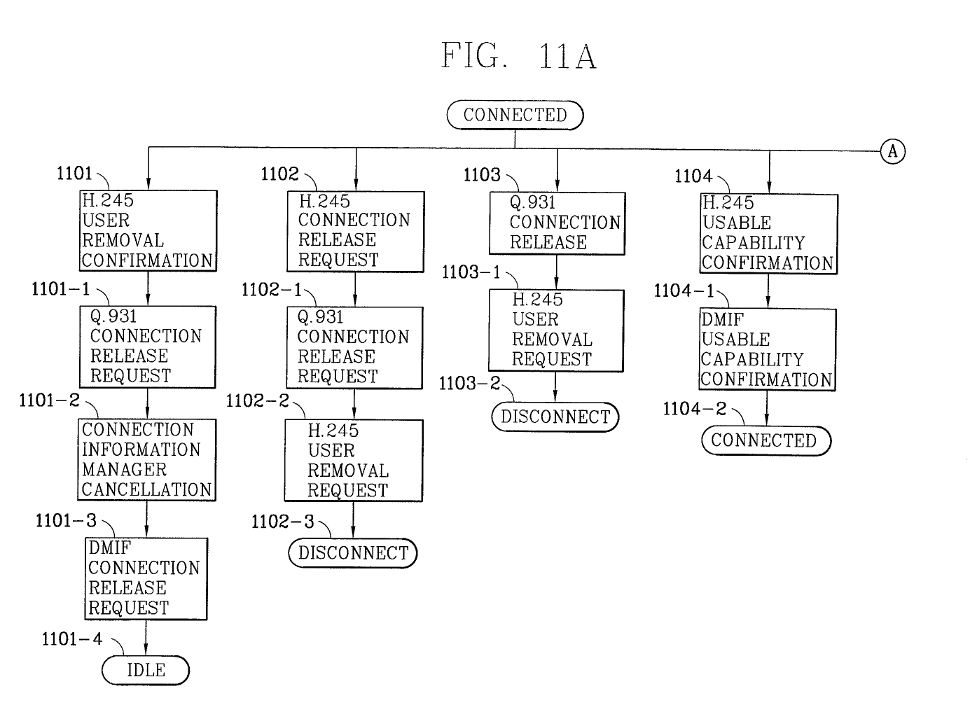

FIG. 10 is a flow chart illustrating a state for finishing the connection which is a CONNECTED state or a CONNECTING state before the transition to the IDLE state.

It is the state waiting the process completion for the control signal connection finish of the H.245, when the control signal connection finish processing is completed, the transition is performed to the IDLE state, it will now be described in detail.

First, when the H.245 user removal confirmation message is received 1001, the Q.931 connection release request message is transmitted 1002, the connection information manager is canceled 1003, the connection release confirmation service is requested to the DMIF 1004, and the transition is performed to the IDLE state 1004-1.

On the contrary, when the H.245 user removal request message is received 1005, the Q.931 connection release request 1006, connection information manager cancellation 1007, DMIF connection release request 1008 processes are performed, and the transition is performed to the IDLE state 1008-1.

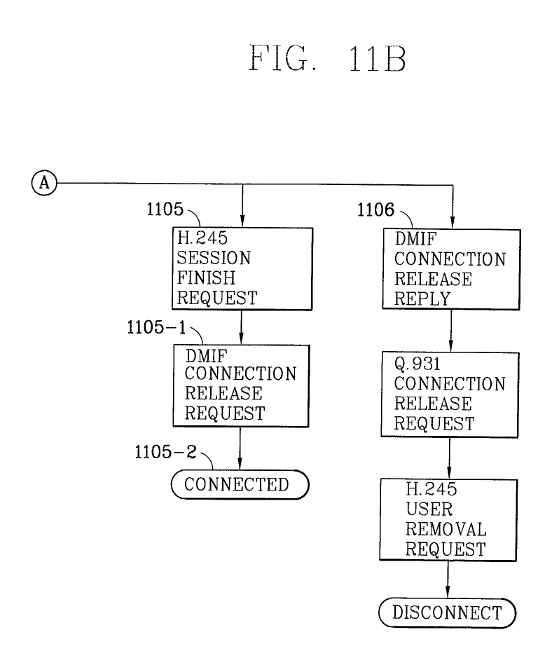

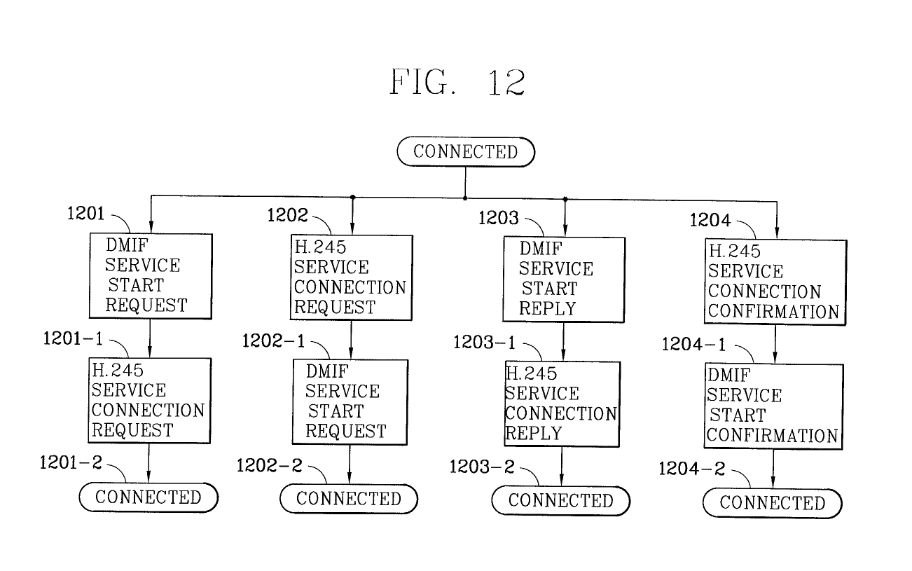

FIG. 11˜FIG. 15 are flow charts of the CONNECTED state in accordance with the present invention.

In other words, as depicted in FIG. 5, in the CONNECTED state 405, a return to itself or transition to the DISCONNECT state 406 or transition to the IDLE state 401 can be performed.

Hereinafter, FIG. 11˜15 are orderly described in detail.

FIG. 11A and 11B illustrate orders related to a message reception and a DMIF connection release request reply in the CONNECTED state in accordance with the present invention.

As depicted in FIG. 11A and 11B, when the H.245 user removal request message is received 1101, the Q.931 connection release request message transmission 1101-1, connection information manager cancellation 1101-2, DMIF connection release request service request are performed 1101-3, and the transition is performed to the IDLE state 1101-4.

In addition, in the DMIF connection release request reply 1102, the Q.931 connection release request message transmission 1102-1, H.245 user removal request message transmission 1102-2 are performed, and the transition is performed to the DISCONNECT state 1102-3.

In addition, in the Q.931 connection release message reception 1103, the H.245 user removal request message is transmitted 1103-1, the transition is performed to the DISCONNECT state 1103-2. In the H.245 available capability confirmation message reception 1104, the DMIF available capability confirmation service is requested 1104-1, the transition is performed to the CONNECTED state 1104-2.

In the H.245 session completion request message reception 1105, the DMIF connection release request is performed 1105-1, and the transition is performed to the CONNECTED state 1105-2.

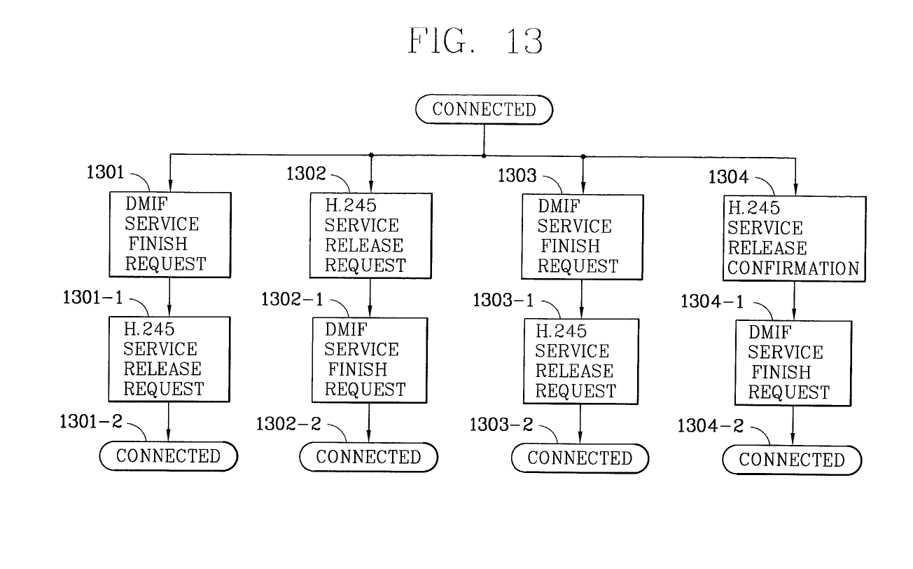

FIG. 12 illustrates order related to a request and a reply of the DMIF service start and H.245 service connection request and confirmation.

As depicted in FIG. 12, when there is the service request reply about the DMIF service start request 1201, the H.245 service connection request message is transmitted 1201-1, and the transition (return) is performed to the CONNECTED state 1201-2.

In addition, when the H.245 service connection request message is received 1202, the DMIF service start request message is transmitted 1202-1, and the transition (return) is performed to the CONNECTED state 1202-2.

After that, when there is the DMIF service start reply 1203, the h.245 service connection reply service is transmitted 1203-1, the transition (return) performed to the CONNECTED state 1203-2, when the H.245 service connection confirmation message is received 1204, the DMIF service start confirmation is transmitted 1204-1, and the transition (return) is performed to the CONNECTED state 1204-2.

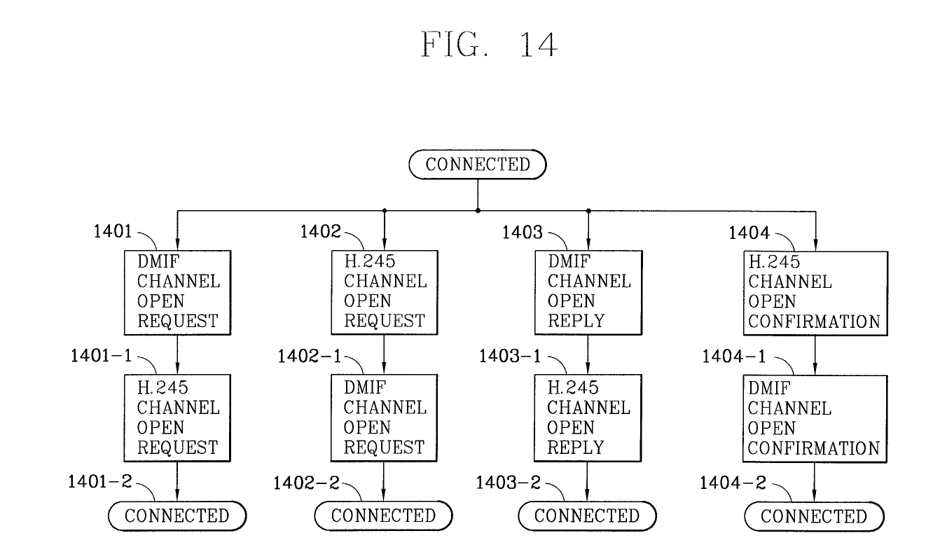

FIG. 13 illustrates order related to a request and a reply of the DMIF service finish and H.245 service release request and confirmation.

As depicted in FIG. 13, in the DMIF service completion request 1301, the H.245 service release request message is transmitted 1301-1, and the transition (return) is performed to the CONNECTED state 1301-2.

In the H.245 service release request message reception 1302, the H.245 service release reply message is transmitted 1303-1, and the transition (return) is performed to the CONNECTED state 1203-2. In the h.245srvice release confirmation message reception 1304, the DMIF service completion confirmation message is transmitted 1304-1, and the transition (return) is performed to the CONNECTED state 1304-2.

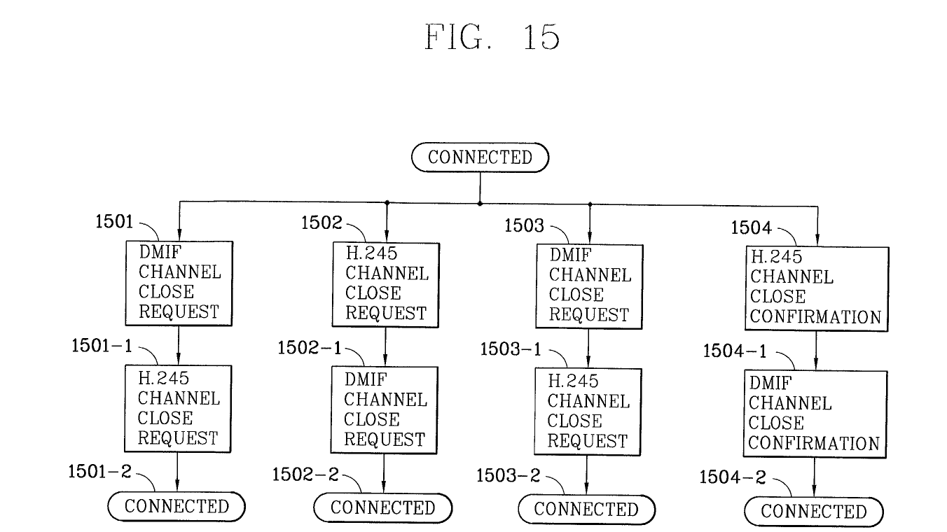

FIG. 14 illustrates order related to the DMIF channel open request and replay and H.245 channel open and confirmation.

As depicted in FIG. 14, in the DMIF channel open request 1401, the H.245 channel open request message is transmitted 1401-1, and the transition (return) is performed to the CONNECTED state 1401-2.

In the H.245 channel open request message reception 1402, the DMIF channel open request message is transmitted 1402-1, and the transition (return) is performed to the CONNECTED state 1402-2.

In addition, in the DMI channel open request 1403, the H.245 channel open reply message is transmitted 1403-1, and the transition (return) is performed to the CONNECTED state 1403-2. In the H.245 channel open confirmation 1404, the DMIF channel open confirmation message is transmitted 1404-1, and the transition (return) is performed to the CONNECTED state 1404-2.

FIG. 15 illustrates orders related to the DMIF channel close request and reply and H.245 channel close request and confirmation.

As depicted in FIG. 15, in the DMIF channel close request 1501, the H.245 channel close request message is transmitted 1501-1, the transition (return) is performed to the CONNECTED state 1501-2. In the H.245 channel close request 1502, the DMIF channel close message is transmitted 1502-1, and the transition (return) is performed to the CONNECTED state 1502-2.

In addition, in the DMIF channel closed reply 1503, the H.245 channel close reply message is transmitted 1503-1, and the transition (return) is performed to the CONNECTED state 1503-2. In the H.245 channel close confirmation 1504, the DMIF channel close confirmation message is transmitted 1504-1, and the transition (return) is performed to the CONNECTED state 1504-2.

As described above, the event in FIG. 12˜FIG. 15 do not alter the state, this kinds of events includes the service start, a signal about the completion, a signal processing required for opening/closing the channel for transmitting the media etc.

As described above, in the embodiment of the video conference system in accordance with the present invention as the dominant unification media communication for the next generation, the present invention is capable of performing the interlocking with the H.323 as the present dominant system with the MPEG4 system which is the next generation system.

In addition, the MPEG4 system in accordance with the present invention can effect the market expansion of the video conference product by interlocking with the H.323 which is the other standard.

In addition, when the present invention is regarded as not a terminal but an independent network apparatus, it is possible to develop products such as a MPEG4-H.323 gate way etc.

In addition, when the present invention is regarded as not a terminal but a system such as a MCU (Multipoint Control Unit), it is possible to communication freely in one space with different standard terminals.

What is claimed is:

1. A video conference control apparatus based on a MPEG4 (Motion Pictures Expert Group4) on an IP network in hierarchical construction of a video conference system on the IP network system, comprising:
a MPEG4 system for performing compression-coding of a multimedia object including a motion picture
a DMIF (Delivery Multimedia Intergration Framework) for transmitting multimedia data including the motion picture from the MPEG4 system through a network in order to perform a video communication;
a control signal conversion and connection management mean for performing a message and a signal conversion in order to provide a service request from the superior hierarchy through a lower hierarchy when a DMIF (Delivery Multimedia Intergration Framework) signal from the DMIF to be transmitted through a network is inputted; and
a H.323 terminal for performing a call and a control signal connection for the video conference by linking with the control signal conversion and connection management mean.

2. The video conference control apparatus based on the MPEG4 on the IP network according to claim 1, wherein the MPEG4 system, DMIF (Delivery Multimedia lntergration Framework), control signal conversion and connection management mean, H.323 terminal are implemented from the superior application hierarchy.

3. The video conference control apparatus based on the MPEG4 on the IP network according to claim 1, wherein the DMIF signal is inputted through a DNI.

4. The video conference control apparatus based on the MPEG4 on the IP network according to claim 1, wherein the lower hierarchy is a H.323 (H.245, Q.931).

5. The video conference control apparatus based on the MPEG4 on the IP network according to claim 1, wherein the control signal conversion and connection management mean comprises:
a connection manager interface for connecting to the superior DMIF with a transmission factor same with the DNI for an inherent DMIF (Delivery Multimedia Intergration Framework) signal;
an input signal synchronization mean for performing synchronization of a service request inputted from the superior DMIF through the connection manager interface and an input signal about a confirmation request from the lower hierarchy, and providing ordered information;
a state management mean for performing a transition control and a service control of a state related to a call and a connection processing for the MPEG4 video conference;
a message interpretation and service distribution mean for performing a service distribution through interpretation and state management of the information synchronized and ordered in the input signal synchronization mean;
a control signal converting mean for converting the signal inputted through the connection manager interface into a service request factor of a signal corresponding to a H.245, Q.931; and
a connection manager information/resources management mean for performing call (Q.931) connection and control signal (H.245) connection management by linking with the message interpretation and service distribution mean and managing the network resources for the control signal channel.

6. The video conference control apparatus based on the MPEG4 on the IP network according to claim 5, wherein the input signal synchronization mean comprises:
a sub module interface for a service request and reply and message reception/transmission with the H.245, Q.931;
an input queue for performing ordering and a mutual exclusion function about an input from the connection manager interface and sub module interface; and
a queue message pump for providing orderly the contents of the input queue for the message interpretation.

7. The video conference control apparatus based on the MPEG4 on the IP network according to claim 5, wherein the message interpretation and service distribution mean comprises:
a message interpretation mean for interpreting the information synchronized and ordered by the input signal synchronization mean, and providing it to the control signal conversion mean; and
a service distribution mean for executing the pertinent service module under the control of the state management mean.

8. The video conference control apparatus based on the MPEG4 on the IP network according to claim 5, wherein the connection manager information/resources management mean comprises:
a network resources management mean for performing allotment of the network resources for the control signal connection and management about the resources information
a connection information management mean for managing connection information of the network and lower hierarchy by the message interpolation and service distribution mean;
a call connection management mean for managing the call connection for the MPEG4 video conference by the connection information management mean; and
a control signal connection management mean for managing the control signal connection for the MPEG4 video conference by the connection information management mean.

9. A video conference control method based on a MPEG4 on an IP network for performing transitions and returns in accordance with conditions of each state in order to perform a video conference with states such as an IDLE, a CALLING, a CALLED, a CONNECTING, a CONNECTED, a DISCONNECT, comprising:
an IDLE state defined as an initial state or a state when a call connection and a control signal connection are not performed;
a CALLING state defined as a state which requests a call connection after receiving a connection request from a user;
a CALLED sate defined as a sate which receives the call connection request from the other party and allows the connection by the user or which requests the call connection to the other party and receives a signal permitting the connection from the other party;
a CONNECTING state defined as a state when the control signal is connected;
a CONNECTED state defined as a sate which finishes the connection process of the control signal; and
a DISCONNECT state defined as a state when a call connection release and control signal connection release are requested.

10. The video conference control method based on the MPEG4 on the IP network according to claim 9, wherein the video conference control method which performs the transitions and returns in accordance with the conditions of the each state comprises:
(a) a transition from the IDLE state to the CALLING state or CALLED state, and a transition (return) from the CONNECTING state or CONNECTED state or DISCONNECT state to the IDLE state;
(b) a transition from the CALLING state to the IDLE state or CALLED state;
(c) a transition from the CALLED state to the IDLE state or CONNECTING state;
(d) a transition from the CONNECTING state to the IDLE state or CONNECTED state or DISCCONNECT state;
(e) a transition from the CONNECTED state to the DISCONNECT state or IDLE state; and
(f) a transition from the DISCONNECT state to the IDLE state.

11. The video conference control method based on the MPEG4 on the IP network according to claim 10, wherein the video conference control method comprises:
(a) a transition from the IDLE state to the CALLED state when a Q.931 call message is received from remote place, a connection confirmation request to the DMIF is performed, a reply about the connection from the DMIF (Delivery Multimedia Intergration Framework) is received and the reply mode setting is requested to a H.245; and
(b) a transition from the IDLE state to the CALLED state when a request is received from a region first, the DMIF requests a connection and call connection request to the remote place is succeed.

12. The video conference control method based on the MPEG4 on the IP network according to claim 10, wherein the video conference control method comprises:
(a) a transition from the CALLING state to the IDLE state when a connection release is requested from the DMIF and a call release is requested from the remote place; and
(b) a transition from the CALLING state to the CALLED state when the reply about the requested call connection is received from the remote place.

13. The video conference control method based on the MPEG4 on the IP network according to claim 10, wherein the video conference control method comprises:
(a) a transition from the CALLED state to the IDLE state when a connection release request is received from the DMIF or a call release request is received from the remote place; and
(b) a transition from the CALLED state to the CONNECTING state while requesting a TCS and MSD signal process of the H.245 when a use right is received from the H.245 (control signal connection).

14. The video conference control method based on the MPEG4 on the IP network according to claim 10, wherein the video conference control method comprises:
(a) a transition from the CONNECTING state to the CONNECTED state when the H.245 is in the connection state;
(b) a transition from the CONNECTING state to the IDLE state when a user removal and a call release request are received from the H.245; and
(c) a transition from the CONNECTING state to the DISCONNECT when a connection release request is received from the DMIF (Delivery Multimedia Intergration Framework).

15. The video conference control method based on the MPEG4 on the IP network according to claim 10, wherein the DISCONNECT state waits until a processing for finishing the control signal connection of the H.245 is completed, and it is altered into the IDLE state when the control signal connection finish processing is completed.

16. The video conference control method based on the MPEG4 on the IP network according to claim 10, wherein the video conference control method comprises:
(a) a transition from the CONNECTED state to the DISCONNECT state when there is a DMIF (Delivery Multimedia Intergration Framework) connection release request (event) for performing the connection release process from the user;
(b) a transition from the CONNECTED state to the DISCONNECT state when a H.245 user removal request for finishing the connection is received from the remote place; and
(c) a transition from the CONNECTED state to the DISCONNECT state when a Q.931 connection release request is received.

17. A video conference control method based on a MPEG4 on an IP network in hierarchical construction of a video conference system on the IP network, comprising:
a DMIF on the superior hierarchy;
a Q.931 and a H.245 on the lower hierarchy;
an interface having a transmission factor same with a DNI in order to perform the MPEG4 video communication through the H.245 and Q.931 when a DMIF signal to be transmitted through a network is inputted through the DNI from the DMIF; and
a service request and reply control mean for controlling a service request and reply by converting the signal inputted through the interface into a service request factor of a signal corresponding to the H.245 and Q.931.
